(19) United States
(12) Patent Application Publication
(10) Pub. No.: US 2025/0071539 A1
(43) Pub. Date: Feb. 27, 2025

(54) INFORMATION PROCESSING METHOD, COMMUNICATION DEVICE, AND STORAGE MEDIUM

(71) Applicant: Beijing Xiaomi Moblie Software Co., Ltd., Beijing (CN)

(72) Inventors: Jianning LIU, Beijing (CN); Yang SHEN, Beijing (CN)

(73) Assignee: Beijing Xiaomi Moblie Software Co., Ltd., Beijing (CN)

(21) Appl. No.: 18/723,962

(22) PCT Filed: Dec. 27, 2021
(86) PCT No.: PCT/CN2021/141812

§ 371 Date: Jun. 25, 2024

(51) Int. Cl. H04W 8/20; H04W 48/14; H04W 60/04

(52) U.S. Cl. CPC H04W 8/20; H04W 48/14; H04W 60/04

(57) ABSTRACT

An information processing method, a communication device, and a storage medium for managing user subscriptions. The user subscriptions are managed by: receiving request information sent by user equipment (UE); where the request information includes identification information of the UE; determining, based on the identification information, whether the UE has an authorized subscription service; and sending, in response to determining that the UE has the authorized subscription service, requested target information to the UE; where the target information includes subscription information requested by the request information.

### CROSS-REFERENCE TO RELATED APPLICATIONS

The present disclosure is a U.S. national phase of PCT Application No. PCT/CN2021/141812 filed on Dec. 27, 2021, the content of which is hereby incorporated by reference in its entirety.

### TECHNICAL FIELD

The present disclosure relates to but is not limited to a field of communication technology, and in particular, to information processing methods and apparatuses, a communication device, and a storage medium.

### BACKGROUND

At present, business operators have very large, real, and reliable subscription data, which has very wide distribution coverage, and has a huge traffic entry and potential commercial value. However, there is currently no suitable technical means and business operator modes to reasonably develop and use the potential commercial value.

### SUMMARY

Embodiments of the present disclosure disclose information processing methods and apparatuses, a communication device, and a storage medium.

According to a first aspect of the present disclosure, an information processing method is provided, that is executed by an AMF network element and includes:
receiving request information sent by UE; where the request information includes identification information (ID) of the UE;
determining whether the UE has an authorized subscription service (ASS) based on the identification information; and
in response to determining that the UE has the authorized subscription service, sending requested target information to the UE; where the target information includes target subscription information requested by the request information.

According to a second aspect of the present disclosure, an information processing method is provided, that is executed by an ASMF network element and includes:
receiving request information sent by an AMF network element; where the request information includes identification information of UE;
determining whether the UE has an authorized subscription service based on the identification information; and
in response to determining that the UE has the authorized subscription service, sending requested target information to the AMF network element; where the target information includes target subscription information requested by the request information.

According to a third aspect of the present disclosure, an information processing method is provided, that is executed by a UDM network element and includes:
receiving request information sent by an AMF network element; where the request information includes identification information of UE;
determining whether the UE has an authorized subscription service based on the identification information; and
in response to determining that the UE has the authorized subscription service, sending requested target information to the AMF network element; where the target information includes target subscription information requested by the request information.

According to a fourth aspect of the present disclosure, a communication device is provided, including:
a processor; and
a memory configured to store instructions executable by the processor;
where the processor is configured to implement, when executing the executable instructions, the information processing method in any embodiment of the present disclosure.

According to a fifth aspect of the present disclosure, a computer storage medium is provided. The computer storage medium stores a program executable by a processor. When the executable program is executed by a processor, the information processing method of any embodiment of the present disclosure is implemented.

It should be understood that the above general description and the detailed description in the following text are only exemplary and explanatory, and cannot limit the embodiments of the present disclosure.

### BRIEF DESCRIPTION OF DRAWINGS

FIG. 1 is a schematic structural diagram of a wireless communication system.

FIG. 2 is a flowchart of an information processing method shown according to an exemplary embodiment.

FIG. 3 is a flowchart of an information processing method shown according to an exemplary embodiment.

FIG. 4 is a flowchart of an information processing method shown according to an exemplary embodiment.

FIG. 5 is a flowchart of an information processing method shown according to an exemplary embodiment.

FIG. 6 is a flowchart of an information processing method shown according to an exemplary embodiment.

FIG. 7 is a flowchart of an information processing method shown according to an exemplary embodiment.

FIG. 8 is a flowchart of an information processing method shown according to an exemplary embodiment.

FIG. 9 is a flowchart of an information processing method shown according to an exemplary embodiment.

FIG. 10 is a flowchart of an information processing method shown according to an exemplary embodiment.

FIG. 11 is a flowchart of an information processing method shown according to an exemplary embodiment.

FIG. 12 is a flowchart of an information processing method shown according to an exemplary embodiment.

FIG. 13 is a flowchart of an information processing method shown according to an exemplary embodiment.

FIG. 14 is a flowchart of an information processing method shown according to an exemplary embodiment.

FIG. 15 is a block diagram of an information processing apparatus shown according to an exemplary embodiment.

FIG. 16 is a block diagram of an information processing apparatus shown according to an exemplary embodiment.

FIG. 17 is a block diagram of an information processing apparatus shown according to an exemplary embodiment.

FIG. 18 is a block diagram of an information processing apparatus shown according to an exemplary embodiment.

FIG. 19 is a block diagram of UE shown according to an exemplary embodiment.

FIG. 20 is a block diagram of a base station shown according to an exemplary embodiment.

### DETAILED DESCRIPTION

Exemplary embodiments will be described in detail herein, with examples thereof represented in the accompanying drawings. When the following description involves the accompanying drawings, the same numerals in different figures represent the same or similar elements, unless otherwise indicated. Implementations described in the following exemplary embodiments do not represent all implementations consistent with embodiments of the present disclosure. On the contrary, they are only examples of apparatuses and methods that are consistent with some aspects of embodiments of the present disclosure as detailed in the attached claims.

Terms used in the embodiments of the present disclosure are only for the purpose of describing specific embodiments and are not intended to limit the embodiments of the present disclosure. Singular forms, “a/an” and “the,” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, the term “if” used herein may be interpreted as “when,” “while,” or “in response to determining.”

When a user has a query requirement, the user often cannot obtain target information or needs to pay more cost to obtain the target information, for example, a sales phone number of a certain product, an outpatient phone number of a certain hospital, an ordering phone number of a certain restaurant, etc., which cannot meet the user requirement in time and also brings great inconvenience. In addition, when commercial customers put in commercial advertisement information, they need to take both cost and coverage into account; the commercial advertisement information often has limited coverage, and cannot respond to a real-time product requirement of the user in time, which causes potential loss.

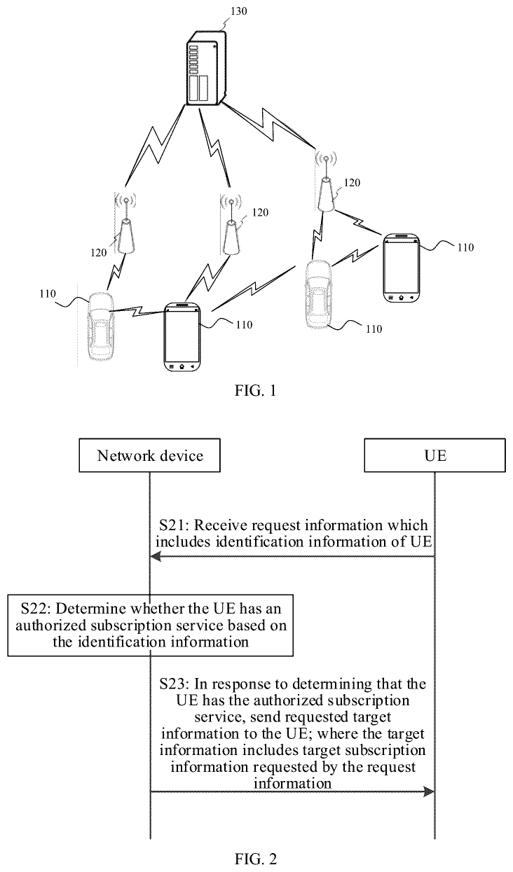

Referring to FIG. 1, FIG. 1 shows a schematic structural diagram of a wireless communication system provided by an embodiment of the present disclosure. As shown in FIG. 1, the wireless communication system is a cellular mobile communication technology-based communication system, and the wireless communication system may include several user equipment 110 and several base stations 120.

The user equipment 110 may be a device that provides voice and/or data connectivity to a user. The user equipment 110 may communicate with one or more core networks through a radio access network (RAN). The user equipment 101 may be Internet of Things user equipment, such as a sensor device, a mobile phone (or referred to as a “cellular” phone), and a computer having the Internet of Things user equipment, for example a fixed, portable, pocket, handheld, computer built-in, or vehicle-mounted apparatus. For example, the user equipment may be a station (STA), a subscriber unit, a subscriber station, a mobile station, a mobile table, a remote station, an access point, a remote terminal, an access terminal, a user terminal, a user agent, or a user device. Alternatively, the user equipment 110 may also be a device of an unmanned aerial vehicle. Alternatively, the user equipment 110 may also be a vehicle-mounted device, for example, a vehicle computer having a wireless communication function, or a wireless user equipment externally connected to a vehicle computer. Alternatively, the user equipment 110 may also be a roadside device, for example, a street lamp, a signal light, other roadside device, etc., having a wireless communication function.

The base station 120 may be a network-side device in the wireless communication system. The wireless communication system may be a 4-th generation mobile communication (4G) system, also referred to as a long term evolution (LTE) system; or the wireless communication system may also be a 5G system, also referred to as a new radio (NR, or new air interface) system or a 5G NR system. Alternatively, the wireless communication system may be a next generation system of the 5G system. An access network in the 5G system may be referred to as a new generation-radio access network (NG-RAN).

The base station 120 may be an evolved Node B (eNB) used in the 4G system. Alternatively, the base station 120 may also be a base station using a centralized distributed architecture (gNB) in the 5G system. When the base station 120 uses the centralized distributed architecture, the base station 120 usually includes a central unit (CU) and at least two distributed units (DUs). The central unit is provided with a protocol stack of a packet data convergence protocol (PDCP) layer, a radio link control (RLC) protocol layer, and a medium access control (MAC) layer; and each of the distributed units is provided with a protocol stack of a physical (PHY) layer. The specific implementation of the base station 120 is not limited in the embodiment of the present disclosure.

A wireless connection may be established between the base station 120 and the user equipment 110 through a wireless air interface. In different implementations, the wireless air interface is a wireless air interface based on a 4-th generation mobile communication network technology (4G) standard; or the wireless air interface is a wireless air interface based on a 5-th generation mobile communication network technology (5G) standard, for example, the wireless air interface is a new radio; or the wireless air interface may also be a wireless air interface based on a next generation mobile communication network technology standard of the 5G.

In some embodiments, an E2E (end to end) connection may also be established between the user equipment 110. For example, there are scenarios, such as vehicle to vehicle (V2V) communication, vehicle to infrastructure (V2I) communication, vehicle to pedestrian (V2P) communication, etc., in vehicle to everything (V2X) communication.

Here, the above user equipment may be considered as a terminal device in the following embodiments.

In some embodiments, the above wireless communication system may further include a network management device 130.

The several base stations 120 are respectively connected to the network management device 130. The network management device 130 may be a core network device in the wireless communication system. For example, the network management device 130 may be a mobility management entity (MME) in an evolved packet core (EPC) network. Alternatively, the network management device may also be another core network device, for example, a serving gateway (SGW), a public data network gateway (PGW), a policy and charging rules function (PCRF) unit, a home subscriber server (HSS), etc. An implementation form of the network management device 130 is not limited to the embodiments of the present disclosure.

For ease of understanding by those skilled in the art, the embodiments of the present disclosure list multiple implementations to clearly describe technical solutions of the embodiments of the present disclosure. Of course, those skilled in the art may understand that the multiple embodiments provided by the embodiments of the present disclosure may be executed separately, or may be executed together with methods of other embodiments in embodiments of the present disclosure, or may be executed separately or together with some methods in other related technologies, which is not limited in the embodiments of the present disclosure.

As shown in FIG. 2, an embodiment of the present disclosure provides an information processing method, executed by a network device, and including the following steps S21-S23.

At step S21, request information is received; where the request information includes identification information of UE.

At step S22, whether the UE has an authorized subscription service is determined, based on the identification information.

At step S23, in response to determining that the UE has the authorized subscription service, requested target information is sent to the UE; where the target information includes target subscription information requested by the request information.

In an embodiment, the network device may be a core network device. The core network device may be one of various function network elements. For example, the network device may be but is not limited to an access and mobility management function (AMF) network element, an authorized subscription management function (ASMF) network element, a unified data management (UDM) network element, or the like.

In another embodiment, the network device may also be an access network device. The access network device may be one of various base stations. For example, the base station may be a 4G base station, a 5G base station, another evolved base station, or the like. When the network device is a base station, the base station receives information sent by the UE and forwards the information to a core network device; or the base station receives information sent by the core network device and forwards the information to the UE.

In an embodiment, the UE may be one of various types of UE. For example, the UE may be but is not limited to a mobile phone, a tablet computer, a wearable device, a smart home device, a smart office device, a wearable device, a game control platform, a multimedia device, or the like.

Receiving request information in the step S21 may include: receiving, by the network device, the request information sent by the UE. For example, the base station receives the request information sent by the UE, and forwards the request information to a core network device, such as an AMF network element.

The identification information of the UE may be to uniquely identify the UE.

In an embodiment, the identification information of the UE may be to determine whether the UE has an authorized service. In another embodiment, the identification information of the UE may be further to request target subscription information of the UE.

Determining whether the UE has an authorized subscription service in the step S22 includes:
determining whether the UE subscribes to the authorized subscription service; or
and/or,
determining whether the UE is authorized to use the authorized subscription service.

The embodiment of the present disclosure provides an information processing method that is executed by a network device. The method may include: determining whether the UE has an authorized subscription service based on identification information of the UE.

Exemplarily, the AMF network element receives request information sent by the base station, where the request information carries identification information of the UE; and the AMF network element determines, based on the identification information of the UE, whether the UE subscribes to an authorized subscription service and/or whether the UE is authorized to use the authorized subscription service, where the request information is sent by the UE to the base station.

Exemplarily, the ASMF network element receives request information sent by the ASMF network element, where the request information carries identification information of the UE; and the ASMF network element determines, based on the identification information of the UE, whether the UE subscribes to an authorized subscription service and/or whether the UE is authorized to use the authorized subscription service.

Exemplarily, the UDM network element receives request information sent by the AMF network element, where the request information carries identification information of the UE; and the UDM network element determines, based on the identification information of the UE, whether the UE subscribes to an authorized subscription service and/or whether the UE is authorized to use the authorized subscription service.

The request information may be for the network device to determine the target subscription information.

In an embodiment, the target subscription information may include authorized subscription information of at least one UE.

In another embodiment, the target subscription information may include one or more sets of authorized subscription information, where one set of authorized subscription information includes authorized subscription information of one or more UE.

In an embodiment, the target subscription information may be but is not limited to at least one of: a phone number, a user name, a user account number, a company name, a company account number, a company employee name, and a teacher in school at a certain time period.

In an embodiment, the request information includes condition information. The condition information may be for the network device to determine a part or all of the target subscription information.

In an embodiment, the condition information may be to determine a part or all of the target subscription information indicated by the condition information. For example, if the condition information indicates a phone number, the target subscription information determined according to the condition information is the phone number. For another example, if the condition information indicates a name of a professor from a certain university in 2021, the target subscription information determined according to the condition information is the name of the professor from the certain university in 2021.

In an embodiment, the target information may include a part or all of the target subscription information requested by the request information.

In another embodiment, the target information may further include identification information of the UE. For example, if the target information includes the target subscription information and the identification information of the UE, the network device may return the target subscription information to the UE corresponding to the identification information.

Sending the requested target information to the UE in the step S23 may include: sending, by the AMF network element, the requested target information to the UE; or sending, by the ASMF network element, the requested target information to the UE; or sending, by the UDM network element, the requested target information to the UE. Here, when sending the requested target information to the UE, the ASMF network element or the UDM network element may send the target information to the AMF network element, and the AMF network element forwards the target information. Sending or forwarding, by the AMF network element, the target information may include: sending, by the AMF network element, the target information to the base station, and forwarding, by the base station, the target information to the UE.

In the embodiment of the present disclosure, the network device may receive the request information including the identification information of the UE, determine, based on the identification information, whether the UE has an authorized subscription service, and when determining that the UE has the authorized subscription service, send target information to the UE, where the target information includes target subscription information requested by the request information. Therefore, when the UE has the authorized subscription service, at least part of the target subscription information may be opened, such that the UE may query the target subscription information. On one hand, requirements such as query of the UE, etc., are facilitated, such that requirements such as life requirements of the users, business requirements, etc., are met; and on the other hand, business operators putting in information etc., are facilitated to promote the put-in information, which may respond to the user requirements in time.

In addition to obtaining information by using manners, such as an application program (APP), etc., a risk of information leakage may also be reduced and information may be updated in time to improve the user experience in the embodiment of the present disclosure. Since a user may not need to provide a telephone number when the user is registered in the APP, an authenticity of the registered user is low, and the risk of the information leakage is increased. However, registration is executed by using UE and the target subscription information is obtained only when determining that the UE has the authorized subscription service, which greatly increases security. When the user is registered in the APP, an update of the information cannot be maintained in time, for example, phone shutdown or number change may cause the information of the registered user to be lost. However, the registration is executed by using the UE, which may be based on the identification information of the UE and does not exist the situation of the phone shutdown or number change, such that occurrence of the situation that the information is lost based on UE registration is reduced, and the user experience is improved.

An embodiment of the present disclosure provides an information processing method, executed by a network device. The method may include:
receiving request information; where the request information includes identification information of UE and condition information; and
sending target information to the UE based on the condition information and the identification information, where the target information includes target subscription information indicated by the condition information.

The request information is to request the target subscription information.

The request information is sent by the UE determining that the UE has an authorized subscription service.

Therefore, in the embodiment of the present disclosure, the network device also may not execute a check for the authorized subscription service of the UE, and may directly default that the UE has the authorized subscription service; and after receiving the request information, the network device sends to the UE the requested target subscription information that is indicated by the condition information in the request information.

Technical solutions provided by the embodiments of the present disclosure may include the following beneficial effects.

In the embodiment of the present disclosure, the network device (for example, an AMF network element, an ASMF network element, or a UDM network element) may receive the request information including the identification information of the UE, determine, based on the identification information, whether the UE has an authorized subscription service, and when determining that the UE has the authorized subscription service, send target information to the UE, where the target information includes target subscription information requested by the request information.

Therefore, when the UE has the authorized subscription service, at least part of the target subscription information may be opened, such that the UE may query the target subscription information. Therefore, on one hand, requirements such as query of the UE, etc., are facilitated, such that requirements such as life requirements of the users, business requirements, etc., are met; and on the other hand, business operators putting in information etc., are facilitated to promote the put-in information, which may respond to the user requirements in time.

The step S21 may include any one of:
receiving a registration request message carrying the request information; or
receiving a service request message carrying the request information.

The information processing method provided by the embodiment of the present disclosure is executed by the network device and may include: receiving a registration request message carrying the request information, or receiving a service request message carrying the request information.

For example, the network device receives a registration request message sent by the UE, where the registration request message carries the request information, or the network device receives a service request message sent by the UE, where the service request message carries the request information.

Therefore, in the embodiment of the present disclosure, the request information may be sent by a registration request message or a service request message sent by the UE, such that the network device obtains the request information based on the received registration request message or service request message. Therefore, two functions, a registration request and a target subscription information request of the authorized subscription service of the UE, may be implemented by a registration request message, or two functions, a service request and the target subscription information request of the authorized subscription service of the UE may be implemented by a service request message, such that a utilization ratio of the registration request message or service request message may be improved, transmission of signaling may be reduced, and then power consumption between the UE and network device may be reduced.

Of course, in other embodiments, the request information may also be carried and be sent through any other realizable message or signaling, which is not limited herein.

It should be noted that those skilled in the art may understand that any method provided in the embodiments of the present disclosure may be executed separately, or may be executed together with some methods in the embodiments of the present disclosure or some methods in related technologies.

The following information processing method is executed by the AMF network element, and is similar to the description of the above information processing method executed by the network device. Technical details that are not disclosed in the embodiment of the information processing method executed by the AMF network element, refer to the description of the example of the information processing method executed by the network device, which are not described herein in detail.

As shown in FIG. 3, an embodiment of the present disclosure provides an information processing method, executed by the AMF network element, and including the following steps S31-S33.

At step S31, request information sent by UE is received; where the request information includes identification information of the UE.

At step S32, whether the UE has an authorized subscription service is determined, based on the identification information.

At step S33, in response to determining that the UE has the authorized subscription service, requested target information is sent to the UE; where the target information includes target subscription information requested by the request information.

In some embodiments of the present disclosure, the request information is the request information in the step 21, the identification information is the identification information in the step S21, the target information is the target information in the step S23, and the target subscription information is the target subscription information in the step S23.

Receiving the request information sent by the UE in the step S31 includes: sending, by the UE, the request information of the UE to the base station, and receiving, by the AMF network element, the request information of the UE forwarded by the base station.

Determining whether the UE has an authorized subscription service in the step S32 includes:
determining whether the UE subscribes to the authorized subscription service; or and/or,
determining whether the UE is authorized to use the authorized subscription service.

The embodiment of the present disclosure provides an information processing method that is executed by the AMF network element. The method may include: determining whether the UE has an authorized subscription service based on the identification information of the UE.

In an embodiment, the request information includes condition information. The condition information may be for the AMF network element to determine at least part of the target subscription information. The at least part of the target subscription information is a part of the target subscription information or all of the target subscription information.

In an embodiment, the target information may include a part or all of the target subscription information requested by the request information.

In another embodiment, the target information may further include the identification information of the UE. For example, if the target information includes the target subscription information and the identification information of the UE, the network device may return the target subscription information to the UE corresponding to the identification information.

The step S31 may include any one of:
receiving a registration request message sent by the UE and carrying the request information; or
receiving a service request message sent by the UE and carrying the request information.

The information processing method provided by the embodiment of the present disclosure is executed by the AMF network element and includes any one of:
receiving a registration request message sent by the UE and carrying the request information; or
receiving a service request message sent by the UE and carrying the request information.

Therefore, in the embodiment of the present disclosure, the AMF network element may receive the request information including the identification information of the UE, determine, based on the identification information, whether the UE has an authorized subscription service, and when determining that the UE has the authorized subscription service, send to the UE the target information including the target subscription information requested by the request information. Therefore, when the UE has the authorized subscription service, at least part of the target subscription information may be opened, such that the UE may query the target subscription information. On one hand, requirements such as query of the UE, etc., are facilitated, such that requirements such as life requirements of the users, business requirements, etc., are met; and on the other hand, business operators putting in information etc., are facilitated to promote the put-in information, which may respond to the user requirements in time.

In addition, two functions, a registration request and a target subscription information request of the authorized subscription service of the UE, may be implemented by a registration request message, or two functions, a service request and the target subscription information request of the authorized subscription service of the UE may be implemented by a service request message, such that a utilization ratio of the registration request message or service request message may be improved, transmission of signaling may be reduced, and then power consumption between the UE and network device may be reduced.

An embodiment of the present disclosure provides an information processing method that is executed by an AMF network element and may include: sending request information to an ASMF network element or a UDM network element.

The step S32 may include: querying authorized management information of the UDM network element based on the identification information, to determine whether the UE has the authorized subscription service.

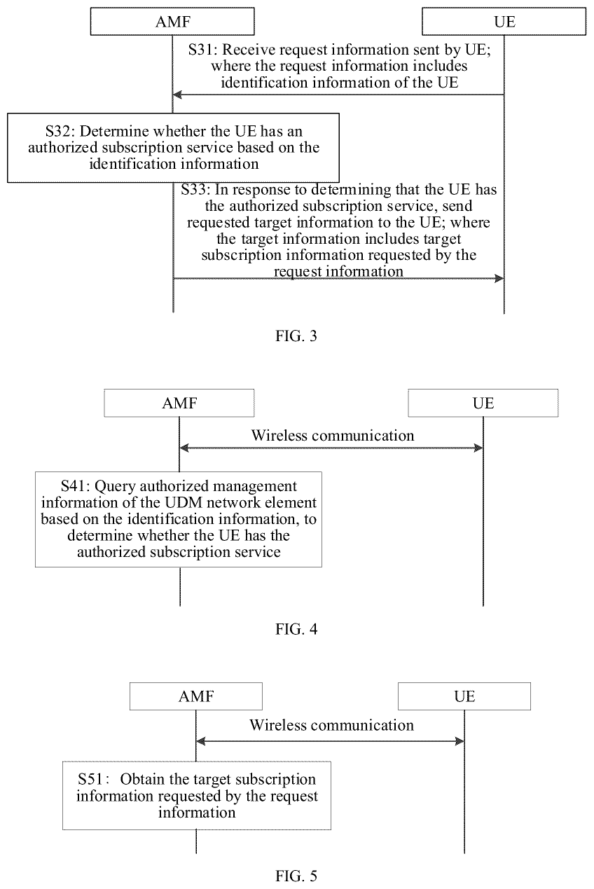

As shown in FIG. 4, an embodiment of the present disclosure provides an information processing method that is executed by the AMF network element and may include the following step S41.

At step S41, authorized management information of the UDM network element is queried based on the identification information, to determine whether the UE has the authorized subscription service.

In some embodiments of the present disclosure, determining whether the UE has the authorized subscription service in the step S41 includes: determining whether the UE subscribes to the authorized subscription service, and/or whether the UE is authorized to use the authorized subscription service.

In some embodiments of the present disclosure, the authorized management information includes: identification information of at least one UE and authorized subscription information corresponding to the identification information; where the authorized subscription information includes: whether the UE subscribes to the authorized subscription service and/or whether the UE is authorized to use the authorized subscription service.

Exemplarily, the AMF network element receives request information forwarded by the base station, where the request information includes the identification information of the UE; and the AMF network element queries the authorized management information of the UDM network element to determine whether the UE has the authorized subscription service. Here, a manner for the AMF network element to query the authorized management information of the UDM network element is that: the AMF network element sends a query request carrying the identification information of the UE to the UDM network element; the UDM network element determines whether the UE has an authorized management service based on the identification information of the UE and the authorized management information, and returns a query result of whether the UE has the authorized management service to the AMF network element; and the AMF network element determines whether the UE has the authorized subscription service based on the received query result.

Therefore, in the embodiment of the present disclosure, whether the UE has the authorized subscription service may be determined, based on the AMF network element, which may be adapted to a scenario in which the AMF network element executes an authorization check.

As shown in FIG. 5, an embodiment of the present disclosure provides an information processing method that is executed by the AMF network element and may include the following step S51.

At step S51, the target subscription information requested by the request information is obtained.

The step S51 may include: obtaining, based on the request information, the target subscription information requested by the request information from a unified data repository (UDR).

The embodiment of the present disclosure provides an information processing method that is executed by the AMF network element and may include: obtaining the target subscription information requested by the request information from a UDR based on the request information.

Exemplarily, if the AMF network element receives the request information sent by the base station, the AMF network element obtains, from the UDR, the target subscription information requested by the request information. For example, in a manner, the AMF network element may obtain all or a part of the target subscription information based on the request information. For another example, in another manner, the AMF network element may obtain the target subscription information of the UE based on the identification information of the UE carried in the request information. For another example, in another manner, the AMF network element may obtain the target subscription information indicated by the condition information of the UE based on the condition information carried in the request information.

Therefore, in the embodiment of the present disclosure, the target subscription information requested by the request information may be retrieved from the UDR based on the AMF network element.

The embodiment of the present disclosure provides an information processing method that is executed by the AMF network element and may include: if determining that UE has the authorized subscription service, obtaining the target subscription information requested by the request information from a UDR based on the request information. Therefore, in the embodiment of the present disclosure, the AMF network element may obtain the target subscription information from the UDR only when the UE has the authorized subscription service, which may thereby reduce a risk of leaking the target subscription information and improve the security of the target subscription information.

The step S51 may include: sending the request information to an ASMF network element; and receiving the target subscription information that is returned by the ASMF network element based on the request information.

An embodiment of the present disclosure provides an information processing method, executed by the AMF network element. The method may include:
sending the request information to an ASMF network element; and
receiving the target subscription information that is returned by the ASMF network element based on the request information.

Exemplarily, after receiving the request information, the AMF network element sends the request information to the ASMF network element; the ASMF network element determines target subscription information based on the request information, and sends the target subscription information to the AMF network element; and the AMF network element receives the target subscription information returned by the ASMF network element.

Therefore, in the embodiment of the present disclosure, the AMF network element may send the request information to the ASMF network element, to obtain the target subscription information by receiving the target subscription information returned by the ASMF network element based on the request information. Therefore, multiple manners to obtain the target subscription information on a side of the AMF network element are provided.

In some embodiments, sending the request information to the ASMF network element includes: in response to determining that the UE has the authorized subscription service, sending the request information to the ASMF network element.

An embodiment of the present disclosure provides an information processing method that is executed by the AMF network element and may include: in response to determining that the UE has the authorized subscription service, sending the request information to the ASMF network element. Therefore, in the embodiment of the present disclosure, only when the UE has the authorized subscription service, the AMF network element sends the request information to the ASMF network element, and then obtains the target subscription information that is determined by the UDM network element based on the request information, which may thereby reduce a risk of leaking the target subscription information and improve the security of the target subscription information.

The step S51 may include: sending the request information to a UDM network element; and receiving the target subscription information that is returned by the UDM network element based on the request information.

An embodiment of the present disclosure provides an information processing method, executed by the AMF network element. The method may include:
sending the request information to a UDM network element; and
receiving the target subscription information that is returned by the UDM network element based on the request information.

Exemplarily, after receiving the request information, the AMF network element sends the request information to the UDM network element; the UDM network element determines target subscription information based on the request information, and sends the target subscription information to the AMF network element; and the AMF network element receives the target subscription information returned by the UDM network element.

Therefore, in the embodiment of the present disclosure, the AMF network element may send the request information to the UDM network element, to obtain the target subscription information by receiving the target subscription information returned by the UDM network element based on the request information. Therefore, multiple manners to obtain the target subscription information on a side of the AMF network element are provided.

An embodiment of the present disclosure provides an information processing method that is executed by the AMF network element and may include: in response to determining that the UE has the authorized subscription service, sending the request information to the UDM network element. Therefore, in the embodiment of the present disclosure, only when the UE has the authorized subscription service, the AMF network element sends the request information to the UDM network element, and then obtains the target subscription information that is determined by the UDM network element based on the request information, which may thereby reduce a risk of leaking the target subscription information and improve the security of the target subscription information.

In some embodiments, the request information includes condition information; and

the step S51 includes: obtaining a part or all of the target subscription information indicated by the condition information based on the condition information.

The embodiment of the present disclosure provides an information processing method that is executed by the AMF network element and may include: based on the condition information, obtaining at least part of the target subscription information indicated by the condition information.

Exemplarily, the condition information indicates phone numbers corresponding to UE1, UE2, and UE3.

If the AMF network element receives the request information including the condition information, the AMF network element may obtain the phone numbers of the UE1, UE2, and UE3 from the UDR.

Therefore, in the embodiment of the present disclosure, if the request information includes the condition information, the AMF network element may, based on the condition information, obtain a part or all of the target subscription information indicated by the condition information, which may thereby accurately obtain the target subscription information, and can both meet requirements, such as life requirements of users, business requirements, etc., and the promotion of business operators, etc.

The above implementation may be specifically described on the side of the network device or on the side of the ASMF network element, which will be not repeated herein.

It should be noted that those skilled in the art may understand that any method provided in the embodiments of the present disclosure may be executed separately, or may be executed together with some methods in the embodiments of the present disclosure or some methods in related technologies.

The following information processing method is executed by the ASMF network element, and is similar to the description of the above information processing method executed by the network device or the AMF network element. Technical details that are not disclosed in the embodiment of the information processing method executed by the ASMF network element, refer to the description of the example of the information processing method executed by the network device or the AMF network element, which are not described herein in detail.

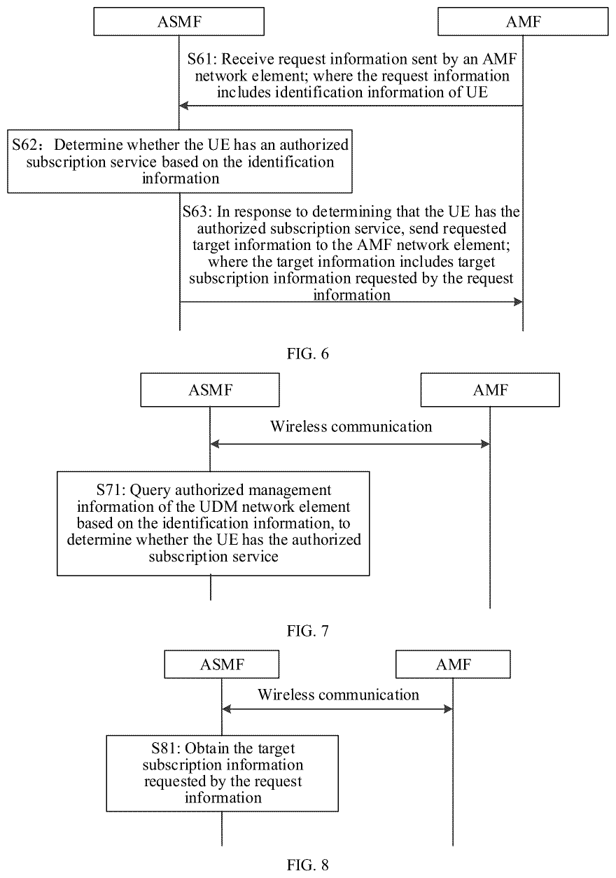

As shown in FIG. 6, an embodiment of the present disclosure provides an information processing method, executed by the ASMF network element, and including the following steps S61-S63.

At step S61, request information sent by an AMF network element is received; where the request information includes identification information of UE.

At step S62, whether the UE has an authorized subscription service is determined, based on the identification information.

At step S63, in response to determining that the UE has the authorized subscription service, requested target information is sent to the AMF network element; where the target information includes target subscription information requested by the request information.

In some embodiments of the present disclosure, the request information is the request information in the step 21, the identification information is the identification information in the step S21, the target information is the target information in the step S23, and the target subscription information is the target subscription information in the step S23.

Determining whether the UE has an authorized subscription service in the step S62 includes:
determining whether the UE subscribes to the authorized subscription service; or and/or,
determining whether the UE is authorized to use the authorized subscription service.

The embodiment of the present disclosure provides an information processing method that is executed by the ASMF network element. The method may include: determining whether the UE has an authorized subscription service based on the identification information of the UE.

In an embodiment, the request information includes condition information. The condition information may be for the ASMF network element to determine at least part of the target subscription information. The at least part of the target subscription information is a part of the target subscription information or all of the target subscription information.

In an embodiment, the target information may include a part or all of the target subscription information requested by the request information.

In another embodiment, the target information may further include identification information of the UE. For example, if the target information includes the target subscription information and the identification information of the UE, the network device may return the target subscription information to the UE corresponding to the identification information.

The step S61 may include any one of:
receiving a registration request message sent by the AMF network element and carrying the request information; or
receiving a service request message sent by the AMF network element and carrying the request information.

The information processing method provided by the embodiment of the present disclosure is executed by the ASMF network element and includes any one of:
receiving a registration request message sent by the AMF network element and carrying the request information; or
receiving a service request message sent by the AMF network element and carrying the request information.

Therefore, in the embodiment of the present disclosure, the ASMF network element may receive the request information sent by the AMF network element and including the identification information of the UE, determine, based on the identification information, whether the UE has an authorized subscription service, and when determining that the UE has the authorized subscription service, send to the AMF network element the target information including the target subscription information requested by the request information. Therefore, when the UE has the authorized subscription service, at least part of the target subscription information may be opened, such that the UE may query the target subscription information. On one hand, requirements such as query of the UE, etc., are facilitated, such that requirements such as life requirements of the users, business requirements, etc., are met; and on the other hand, business operators putting in information etc., are facilitated to promote the put-in information, which may respond to the user requirements in time.

In addition, two functions, a registration request and a target subscription information request of the authorized subscription service of the UE, may be implemented by a registration request message, or two functions, a service request and the target subscription information request of the authorized subscription service of the UE may be implemented by a service request message, such that a utilization ratio of the registration request message or service request message may be improved, transmission of signaling may be reduced, and then power consumption between the UE and network device may be reduced.

The step S62 may include: querying authorized management information of the UDM network element based on the identification information, to determine whether the UE has the authorized subscription service.

As shown in FIG. 7, an embodiment of the present disclosure provides an information processing method that is executed by the ASMF network element and may include the following step S71.

At step S71, authorized management information of the UDM network element is queried based on the identification information, to determine whether the UE has the authorized subscription service.

In some embodiments of the present disclosure, determining whether the UE has the authorized subscription service in the step S71 includes: determining whether the UE subscribes to the authorized subscription service, and/or whether the UE is authorized to use the authorized subscription service.

In some embodiments of the present disclosure, the authorized management information includes: identification information of at least one UE and authorized subscription information corresponding to the identification information; where the authorized subscription information includes: whether the UE subscribes to the authorized subscription service and/or whether the UE is authorized to use the authorized subscription service.

Exemplarily, the ASMF network element receives request information sent by the AMF network element, where the request information includes the identification information of the UE; and the ASMF network element queries the authorized management information of the UDM network element to determine whether the UE has the authorized subscription service. Here, a manner for the ASMF network element to query the authorized management information of the UDM network element is that: the ASMF network element sends a query request carrying the identification information of the UE to the UDM network element; the UDM network element determines whether the UE has an authorized management service based on the identification information of the UE and the authorized management information, and returns a query result of whether the UE has the authorized management service to the ASMF network element; and the ASMF network element determines whether the UE has the authorized subscription service based on the received query result.

Therefore, in the embodiment of the present disclosure, whether the UE has the authorized subscription service may be determined, based on the ASMF network element, which may be adapted to a scenario in which the ASMF network element executes an authorization check.

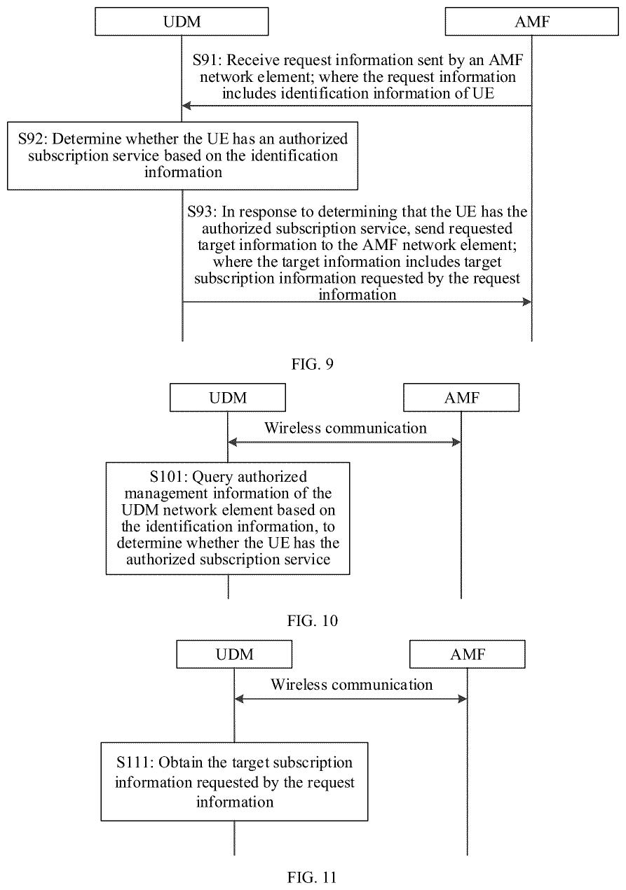

As shown in FIG. 8, an embodiment of the present disclosure provides an information processing method that is executed by the ASMF network element and may include the following step S81.

At step S81, the target subscription information requested by the request information is obtained.

The step S81 may include: obtaining, based on the request information, the target subscription information requested by the request information from a UDR.

The embodiment of the present disclosure provides an information processing method that is executed by the ASMF network element and may include: obtaining the target subscription information requested by the request information from a UDR based on the request information.

Exemplarily, if the ASMF network element receives the request information sent by the AMF network element, the ASMF network element obtains, from the UDR, the target subscription information requested by the request information. For example, in a manner, the ASMF network element may obtain all or a part of the target subscription information based on the request information. For another example, in another manner, the ASMF network element may obtain the target subscription information of the UE based on the identification information of the UE carried in the request information. For still another example, in still another manner, the ASMF network element may obtain the target subscription information indicated by the condition information of the UE, based on the condition information carried in the request information.

Therefore, in the embodiment of the present disclosure, the target subscription information requested by the request information may be retrieved from the UDR based on the ASMF network element.

The embodiment of the present disclosure provides an information processing method that is executed by the ASMF network element and may include: if determining that UE has the authorized subscription service, obtaining the target subscription information requested by the request information from a UDR based on the request information. Therefore, in the embodiment of the present disclosure, the ASMF network element may obtain the target subscription information from the UDR only when the UE has the authorized subscription service, which may thereby reduce a risk of leaking the target subscription information and improve the security of the target subscription information.

The step S81 may include: determining the target subscription information according to the request information.

The embodiment of the present disclosure provides an information processing method that is executed by the ASMF network element and may include: determining the target subscription information according to the request information.

Exemplarily, the ASMF network element receives the request information sent by the AMF network element, and the ASMF network element determines the target subscription information according to the request information. Here, a manner in which the ASMF network element determines the target subscription information according to the request information is that: the ASMF network element queries the stored target subscription information based on the request information, to determine the target subscription information requested by the request information. For example, the ASMF network element stores target subscription information of at least one UE, and the request information is to request a company name corresponding to the UE; and then the ASMF network element may find, from the stored target subscription information of the UE, the company name corresponding to the UE requested by the request information.

Therefore, in the embodiment of the present disclosure, the ASMF network element may determine the target subscription information according to the request information. Therefore, the target subscription information requested by the request information may be accurately determined, and a manner adapted to obtaining the target subscription information on the side of the ASMF network element is provided.

In some embodiments, determining the target subscription information according to the request information includes:
in response to determining that the UE has the authorized subscription service, determining the target subscription information according to the request information.

The embodiment of the present disclosure provides an information processing method that is executed by the ASMF network element and may include: in response to determining that the UE has the authorized subscription service, determining the target subscription information according to the request information.

Therefore, in the embodiment of the present disclosure, only when determining that the UE has the authorized subscription service, the ASMF network element determines the target subscription information based on the request information, which may thereby reduce a risk of leaking the target subscription information and improve the security of the target subscription information.

In some embodiments, the request information includes condition information; and

the step S81 includes: based on the condition information, obtaining at least part of the target subscription information indicated by the condition information.

The embodiment of the present disclosure provides an information processing method that is executed by the ASMF network element and may include: based on the condition information, obtaining at least part of the target subscription information indicated by the condition information.

Exemplarily, the condition information indicates phone numbers corresponding to UE1, UE2, and UE3.

If the ASMF network element receives the request information including the condition information sent by the AMF network element, the ASMF network element determines the phone numbers of the UE1, UE2, and UE3 from the target subscription information stored in the ASMF network element based on the condition information, or obtains the phone numbers of the UE1, UE2, and UE3 from the UDR; and the ASMF network element sends the target subscription information including the identification information of the UE1 and the phone number of the UE1, the identification information of the UE2 and the phone number of the UE2, and the identification information of the UE3 and the phone number of the UE3 to the AMF network element. Here, the target subscription information further includes the identification information of the UE, and the identification information included in the target subscription information indicates that the UE obtained the target subscription information. In this example, if the request information is sent by UE4, the ASMF network element may also send the identification information of the UE4 and the target subscription information to the AMF network element.

Therefore, in the embodiment of the present disclosure, if the request information includes the condition information, the ASMF network element may, based on the condition information, obtain a part or all of the target subscription information indicated by the condition information, which may thereby accurately obtain the target subscription information, and can both meet requirements, such as life requirements of users, business requirements, etc., and the promotion of business operators, etc.

The above implementation may be specifically described on the side of the network device or on the side of the AMF network element, which will be not repeated herein.

It should be noted that those skilled in the art may understand that any method provided in the embodiments of the present disclosure may be executed separately, or may be executed together with some methods in the embodiments of the present disclosure or some methods in related technologies.

The following information processing method is executed by the UDM network element, and is similar to the description of the above information processing method executed by the network device, the AMF network element, or the ASMF network element. Technical details that are not disclosed in the embodiment of the information processing method executed by the UDM network element, refer to the description of the example of the information processing method executed by the network device, the AMF network element, or the ASMF network element, which are not described herein in detail.

As shown in FIG. 9, an embodiment of the present disclosure provides an information processing method, executed by the UDM network element, and including the following steps S91-S93.

At step S91, request information sent by an AMF network element is received; where the request information includes identification information of UE.

At step S92, whether the UE has an authorized subscription service is determined, based on the identification information.

At step S93, in response to determining that the UE has the authorized subscription service, requested target information is sent to the AMF network element; where the target information includes target subscription information requested by the request information.

In some embodiments of the present disclosure, the request information is the request information in the step 21, the identification information is the identification information in the step S21, the target information is the target information in the step S23, and the target subscription information is the target subscription information in the step S23.

Determining whether the UE has an authorized subscription service in the step S92 includes:
determining whether the UE subscribes to the authorized subscription service; or and/or,
determining whether the UE is authorized to use the authorized subscription service.

The embodiment of the present disclosure provides an information processing method that is executed by the UDM network element. The method may include: determining whether the UE has an authorized subscription service based on the identification information of the UE.

In an embodiment, the request information includes condition information. The condition information may be for the UDM network element to determine at least part of the target subscription information. The at least part of the target subscription information is a part of the target subscription information or all of the target subscription information.

In an embodiment, the target information may include a part or all of the target subscription information requested by the request information.

In another embodiment, the target information may further include identification information of the UE. For example, if the target information includes the target subscription information and the identification information of the UE, the network device may return the target subscription information to the UE corresponding to the identification information.

The step S91 may include any one of:
receiving a registration request message sent by the AMF network element and carrying the request information; or
receiving a service request message sent by the AMF network element and carrying the request information.

The information processing method provided by the embodiment of the present disclosure is executed by the UDM network element and includes any one of:
receiving a registration request message sent by the AMF network element and carrying the request information; or
receiving a service request message sent by the AMF network element and carrying the request information.

Therefore, in the embodiment of the present disclosure, the UDM network element may receive the request information sent by the AMF network element and including the identification information of the UE, determine, based on the identification information, whether the UE has an authorized subscription service, and when determining that the UE has the authorized subscription service, send to the AMF network element the target information including the target subscription information requested by the request information. Therefore, when the UE has the authorized subscription service, at least part of the target subscription information may be opened, such that the UE may query the target subscription information. On one hand, requirements such as query of the UE, etc., are facilitated, such that requirements such as life requirements of the users, business requirements, etc., are met; and on the other hand, business operators putting in information etc., are facilitated to promote the put-in information, which may respond to the user requirements in time.

In addition, two functions, a registration request and a target subscription information request of the authorized subscription service of the UE, may be implemented by a registration request message, or two functions, a service request and the target subscription information request of the authorized subscription service of the UE may be implemented by a service request message, such that a utilization ratio of the registration request message or service request message may be improved, transmission of signaling may be reduced, and then power consumption between the UE and network device may be reduced.

The step S92 may include: querying authorized management information of the UDM network element based on the identification information, to determine whether the UE has the authorized subscription service.

As shown in FIG. 10, an embodiment of the present disclosure provides an information processing method that is executed by the UDM network element and may include the following step S101.

At step S101, authorized management information of the UDM network element is queried based on the identification information, to determine whether the UE has the authorized subscription service.

In some embodiments of the present disclosure, determining whether the UE has the authorized subscription service in the step S101 includes: determining whether the UE subscribes to the authorized subscription service, and/or whether the UE is authorized to use the authorized subscription service.

In some embodiments of the present disclosure, the authorized management information includes: identification information of at least one UE and authorized subscription information corresponding to the identification information; where the authorized subscription information includes: whether the UE subscribes to the authorized subscription service and/or whether the UE is authorized to use the authorized subscription service.

Exemplarily, the UDM network element receives request information sent by the AMF network element, where the request information includes the identification information of the UE; and the UDM network element determines whether the UE has the authorized subscription service, based on the identification information of the UE and the authorized management information.

Therefore, in the embodiment of the present disclosure, whether the UE has the authorized subscription service may be determined, based on the UDM network element, which may be adapted to a scenario in which the UDM network element executes an authorization check.

As shown in FIG. 11, an embodiment of the present disclosure provides an information processing method that is executed by the UDM network element and may include the following step S111.

At step S111, the target subscription information requested by the request information is obtained.

The step S111 may include: obtaining, based on the request information, the target subscription information requested by the request information from a UDR.

The embodiment of the present disclosure provides an information processing method that is executed by the UDM network element and may include: obtaining the target subscription information requested by the request information from a UDR based on the request information.

Exemplarily, if the UDM network element receives the request information sent by the AMF network element, the UDM network element obtains, from the UDR, the target subscription information requested by the request information. For example, in a manner, the UDM network element may obtain all or a part of the target subscription information based on the request information. For another example, in another manner, the UDM network element may obtain the target subscription information of the UE based on the identification information of the UE carried in the request information. For another example, in another manner, the UDM network element may obtain the target subscription information indicated by the condition information of the UE based on the condition information carried in the request information.

Therefore, in the embodiment of the present disclosure, the target subscription information requested by the request information may be retrieved from the UDR based on the UDM network element.

The embodiment of the present disclosure provides an information processing method that is executed by the UDM network element and may include: if determining that UE has the authorized subscription service, obtaining the target subscription information requested by the request information from a UDR based on the request information. Therefore, in the embodiment of the present disclosure, the UDM network element may obtain the target subscription information from the UDR only when the UE has the authorized subscription service, which may thereby reduce a risk of leaking the target subscription information and improve the security of the target subscription information.

The step S111 may include: determining the target subscription information according to the request information.

The embodiment of the present disclosure provides an information processing method that is executed by the UDM network element and may include: determining the target subscription information according to the request information.

Exemplarily, the UDM network element receives the request information sent by the AMF network element, and the UDM network element determines the target subscription information according to the request information. Here, a manner for the UDM network element to determine the target subscription information according to the request information is that: the UDM network element queries the stored target subscription information based on the request information, to determine the target subscription information requested by the request information.

Therefore, in the embodiment of the present disclosure, the UDM network element may determine the target subscription information according to the request information. Therefore, the target subscription information requested by the request information may be accurately determined, and a manner adapted to obtaining the target subscription information on the side of the UDM network element is provided.

In some embodiments, determining the target subscription information according to the request information includes:
in response to determining that the UE has the authorized subscription service, determining the target subscription information according to the request information.

The embodiment of the present disclosure provides an information processing method that is executed by the UDM network element and may include: in response to determining that the UE has the authorized subscription service, determining the target subscription information according to the request information.

Therefore, in the embodiment of the present disclosure, only when determining that the UE has the authorized subscription service, the UDM network element determines the target subscription information based on the request information, which may thereby reduce a risk of leaking the target subscription information and improve the security of the target subscription information.

In some embodiments, the request information includes condition information; and

the step S111 includes: based on the condition information, obtaining at least part of the target subscription information indicated by the condition information.

The embodiment of the present disclosure provides an information processing method that is executed by the UDM network element and may include: based on the condition information, obtaining at least part of the target subscription information indicated by the condition information.

Exemplarily, the condition information indicates phone numbers corresponding to UE1, UE2, and UE3.

Alternatively, if the UDM network element receives the request information including the condition information sent by the AMF network element, the UDM network element determines the phone numbers of the UE1, UE2, and UE3 from the target subscription information stored in the UDM network element based on the condition information, or obtains the phone numbers of the UE1, UE2, and UE3 from the UDR; and the UDM network element sends the target subscription information including the identification information of the UE1 and the phone number of the UE1, the identification information of the UE2 and the phone number of the UE2, and the identification information of the UE3 and the phone number of the UE3 to the AMF network element. Here, the target subscription information further includes the identification information of the UE; and the identification information included in the target subscription information indicates the UE obtaining the target subscription information. In this example, if the request information is sent by UE4, the UDM network element may also send the identification information of the UE4 and the target subscription information to the AMF network element.

Therefore, in the embodiment of the present disclosure, if the request information includes the condition information, the UDM network element may, based on the condition information, obtain a part or all of the target subscription information indicated by the condition information. Therefore, multiple manners to accurately obtain the target subscription information are provided. Therefore, both requirements, such as life requirements of users, business requirements, etc., and the promotion of business operators, etc., can be met.

The above implementation may be specifically described on the side of the network device, on the side of the AMF network element, or on the side of the ASMF network element, which will be not repeated herein.

It should be noted that those skilled in the art may understand that any method provided in the embodiments of the present disclosure may be executed separately, or may be executed together with some methods in the embodiments of the present disclosure or some methods in related technologies.

The following information processing method is executed by the UE, and is similar to the description of the above information processing method executed by the network device (such as the AMF network element, the ASMF network element, or the UDM network element). Technical details that are not disclosed in the embodiment of the information processing method executed by the UE, refer to the description of the example of the information processing method executed by the network device, which are not described herein in detail.

An embodiment of the present disclosure provides an information processing method, executed by the UE. The method may include:
sending request information; where the request information includes identification information of the UE; and
receiving target information that is returned based on the request information; where the target information is sent by a network device when determining that the UE has an authorized subscription service; the target information includes at least target subscription information requested by the request information.

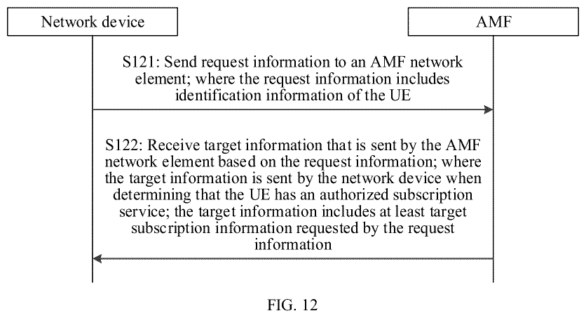

As shown in FIG. 12, an embodiment of the present disclosure provides an information processing method, executed by the UE, and including the following steps S121-S122.

At step S121, request information is sent to an AMF network element; where the request information includes identification information of the UE.

At step S122, target information sent by the AMF network element based on the request information is received; where the target information is sent by a network device when determining that the UE has an authorized subscription service; the target information includes at least target subscription information requested by the request information.

The step S121 includes: sending a registration request message carrying the request information; or sending a service request message carrying the request information.

An embodiment of the present disclosure provides an information processing method that is executed by the UE and may include: sending a registration request message carrying the request information, or sending a service request message carrying the request information.

In some embodiments, the identification information is for the network device to determine at least one of:
whether the UE subscribes to the authorized subscription service; or
whether the UE is authorized to use the authorized subscription service.

In some embodiments, before the step S121, the method further includes: determining that the UE subscribes to the authorized subscription service and/or the UE is authorized to use the authorized subscription service.

The embodiment of the present disclosure provides an information processing method that is executed by the UE. The method may include: determining that the UE subscribes to the authorized subscription service and/or the UE is authorized to use the authorized subscription service.

In some embodiments, the request information is for the network device to determine the target subscription information requested by the request information.

In some embodiments, the request information includes condition information, where the condition information is for the network device to determine a part or all of the target subscription information, indicated by the condition information.

In some embodiments, the network device includes any one of: an ASMF network element, an AMF network element, or a UDM network element.

In some embodiments, the target information further includes the identification information of the UE.

The above implementation may be specifically described on the side of the network device, which will be not repeated herein.

It should be noted that those skilled in the art may understand that any method provided in the embodiments of the present disclosure may be executed separately, or may be executed together with some methods in the embodiments of the present disclosure or some methods in related technologies.

To further explain any embodiment of the present disclosure, several specific embodiments are provided below.

In a first example, the AMF network element executes an authorization check for the UDM network element, determines whether the UE subscribes to the authorized subscription service, and determines whether the UE is authorized to use the authorized subscription service.

Here, the authorization check may include: determining whether the UE has the authorized subscription service in the above embodiment.

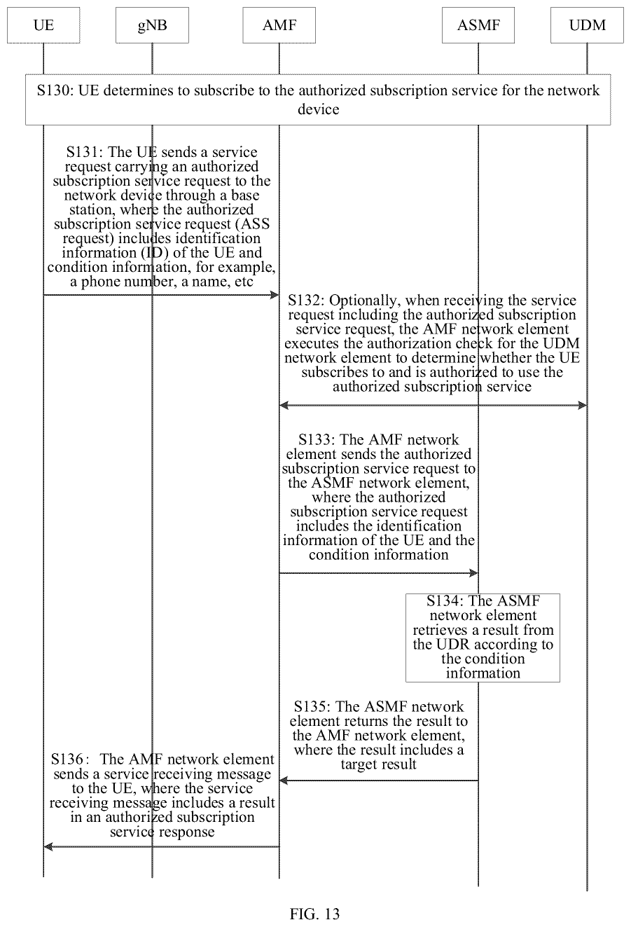

As shown in FIG. 13, an embodiment of the present disclosure provides an information processing method that is applied to a communication device and may include the following steps S130-S136.

At step S130, the UE determines to subscribe to the authorized subscription service for the network device.

Here, the network device includes at least one of: an AMF network element, an ASMF network element, and a UDM network element.

At step S131, the UE sends a service request carrying an authorized subscription service request to the network device through a base station, where the authorized subscription service request (ASS request) includes identification information (ID) of the UE and condition information, for example, a phone number, a name, etc.

Here, the authorized subscription service request is the request information in the above embodiments.

At step S132, optionally, when receiving the service request including the authorized subscription service request, the AMF network element executes the authorization check for the UDM network element to determine whether the UE subscribes to and is authorized to use the authorized subscription service.

At step S133, the AMF network element sends the authorized subscription service request to the ASMF network element, where the authorized subscription service request includes the identification information of the UE and the condition information.

At step S134, the ASMF network element retrieves a result from the UDR according to the condition information.

Here, the result is the target subscription information determined in the above embodiments.

At step S135, the ASMF network element returns the result to the AMF network element, where the result includes a target result.

At step S136, the AMF network element sends a service receiving message to the UE, where the service receiving message includes a result in an authorized subscription service response.

It should be noted that those skilled in the art may understand that any method provided in the embodiments of the present disclosure may be executed separately, or may be executed together with some methods in the embodiments of the present disclosure or some methods in related technologies.

In a second example, the ASMF network element executes an authorization check for the UDM network element, determines whether the UE subscribes to the authorized subscription service, and determines whether the UE is authorized to use the authorized subscription service.

Here, the authorization check may include: determining whether the UE has the authorized subscription service in the above embodiments.

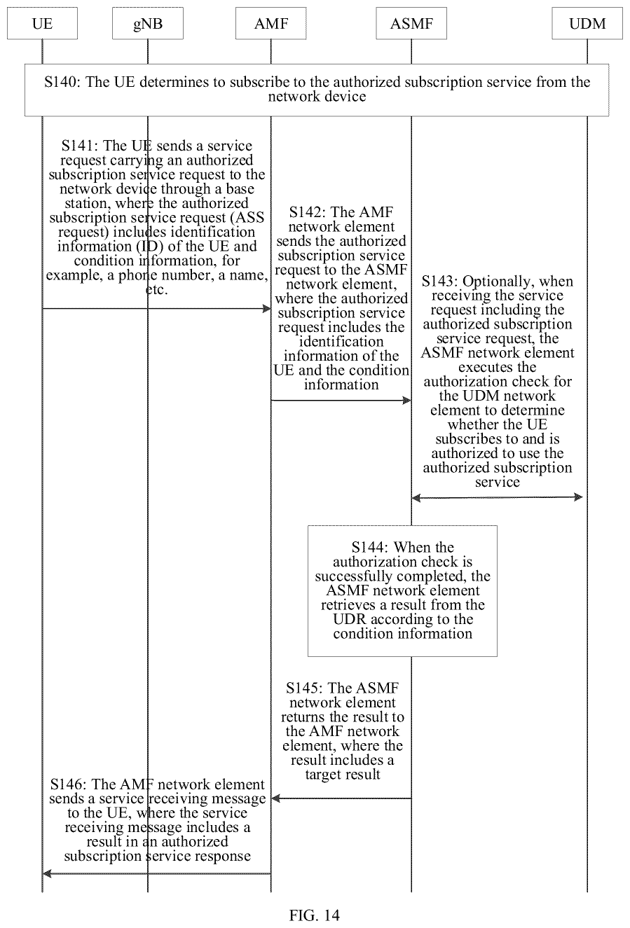

As shown in FIG. 14, an embodiment of the present disclosure provides an information processing method that is applied to a communication device and may include the following steps S140-S146.

At step S140, the UE determines to subscribe to the authorized subscription service for the network device.

Here, the network device includes at least one of: an AMF network element, an ASMF network element, and a UDM network element.

At step S141, the UE sends a service request carrying an authorized subscription service request to the network device through a base station, where the authorized subscription service request (ASS request) includes identification information (ID) of the UE and condition information, for example, a phone number, a name, etc.

At step S142, the AMF network element sends the authorized subscription service request to the ASMF network element, where the authorized subscription service request includes the identification information of the UE and the condition information.

At step S143, optionally, when receiving the service request including the authorized subscription service request, the ASMF network element executes the authorization check for the UDM network element to determine whether the UE subscribes to and is authorized to use the authorized subscription service.

At step S144, when the authorization check is successfully completed, the ASMF network element retrieves a result from the UDR according to the condition information.

Here, the successful completion of the authorization check includes: determining that the UE subscribes to the authorized subscription service and the UE is authorized to use the authorized subscription service.

At step S145, the ASMF network element returns the result to the AMF network element, where the result includes a target result.

At step S146, the AMF network element sends a service receiving message to the UE, where the service receiving message includes a result in an authorized subscription service response.

It should be noted that those skilled in the art may understand that any method provided in the embodiments of the present disclosure may be executed separately, or may be executed together with some methods in the embodiments of the present disclosure or some methods in related technologies.

An embodiment of the present disclosure provides an information processing apparatus, applied to a network device. The apparatus may include:
a receiving module, configured to receive request information; where the request information includes identification information of the UE;
a determination module, configured to determine, based on the identification information, whether the UE has an authorized subscription service; and
a sending module, configured to send, in response to determining that the UE has the authorized subscription service, requested target information to the UE; where the target information includes target subscription information requested by the request information.

In some embodiments, the network devices include an ASMF network element, an AMF network element, and a UDM network element.

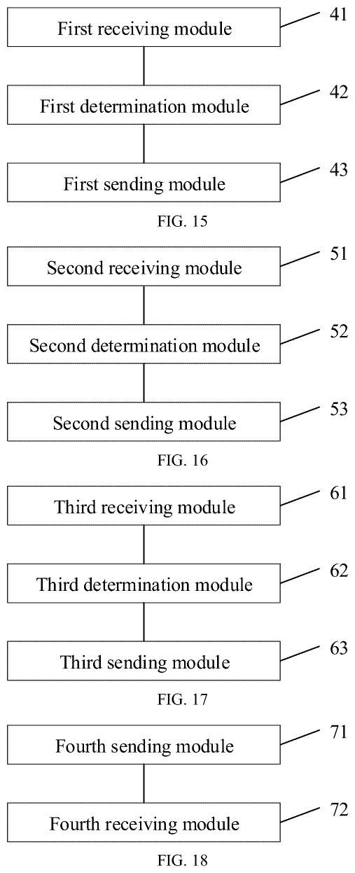

As shown in FIG. 15, an embodiment of the present disclosure provides an information processing apparatus that is applied to the AMF network element and may include:
a first receiving module 41, configured to receive request information sent by UE; where the request information includes identification information of the UE;
a first determination module 42, configured to determine, based on the identification information, whether the UE has an authorized subscription service; and
a first sending module 43, configured to send, in response to determining that the UE has the authorized subscription service, requested target information to the UE; where the target information includes target subscription information requested by the request information.

An embodiment of the present disclosure provides an information processing apparatus that is applied to an AMF network element and may include: the first receiving module 41, configured to receive a registration request message sent by the UE and carrying request information.

An embodiment of the present disclosure provides an information processing apparatus that is applied to an AMF network element and may include: the first receiving module 41, configured to receive a service request message sent by the UE and carrying request information.

In some embodiments, determining whether the UE has the authorized subscription service includes:
determining whether the UE subscribes to the authorized subscription service; or and/or,
determining whether the UE is authorized to use the authorized subscription service.

An embodiment of the present disclosure provides an information processing apparatus that is applied to the AMF network element and may include: the first determination module 42, configured to determine whether the UE subscribes to the authorized subscription service and/or the UE is authorized to use the authorized subscription service.

An embodiment of the present disclosure provides an information processing apparatus that is applied to the AMF network element and may include: the first determination module 42, configured to determine, based on identification information of the UE, whether the UE subscribes to the authorized subscription service and/or the UE is authorized to use the authorized subscription service.

An embodiment of the present disclosure provides an information processing apparatus that is applied to the AMF network element and may include: the first determination module 42, configured to query authorized management information of the UDM network element based on the identification information, to determine whether the UE has the authorized subscription service.

An embodiment of the present disclosure provides an information processing apparatus that is applied to the AMF network element and may include: a first processing module, configured to obtain the target subscription information requested by the request information.

An embodiment of the present disclosure provides an information processing apparatus that is applied to the AMF network element and may include: the first processing module, configured to obtain, based on the request information, the target subscription information requested by the request information from a unified data repository (UDR).

An embodiment of the present disclosure provides an information processing apparatus that is applied to the AMF network element and may include: the first processing module, configured to send the request information to an ASMF network element, and receive the target subscription information that is returned by the ASMF network element based on the request information.

An embodiment of the present disclosure provides an information processing apparatus that is applied to the AMF network element and may include: the first processing module, configured to send the request information to the ASMF network element, in response to determining that the UE has the authorized subscription service.

An embodiment of the present disclosure provides an information processing apparatus that is applied to the AMF network element and may include: the first processing module, configured to send the request information to a UDM network element, and receive the target subscription information that is returned by the UDM network element based on the request information.

In some embodiments, the request information includes condition information.

An embodiment of the present disclosure provides an information processing apparatus that is applied to an AMF network element and may include: the first processing module, configured to obtain, based on the condition information, a part or all of the target subscription information indicated by the condition information.

In some embodiments, the target information further includes the identification information of the UE.

As shown in FIG. 16, an embodiment of the present disclosure provides an information processing apparatus that is applied to the ASMF network element and may include:
a second receiving module 51, configured to receive request information sent by an AMF network element; where the request information includes identification information of UE;
a second determination module 52, configured to determine, based on the identification information, whether the UE has an authorized subscription service; and
a second sending module 53, configured to send, in response to determining that the UE has the authorized subscription service, requested target information to the AMF network element; where the target information includes target subscription information requested by the request information.

An embodiment of the present disclosure provides an information processing apparatus that is applied to an ASMF network element and may include: the second receiving module 51, configured to receive a registration request message sent by the AMF network element and carrying request information.

An embodiment of the present disclosure provides an information processing apparatus that is applied to an ASMF network element and may include: the second receiving module 51, configured to receive a service request message sent by the AMF network element and carrying request information.

An embodiment of the present disclosure provides an information processing apparatus that is applied to an ASMF network element and may include:
the second determination module 52, configured to determine whether the UE subscribes to the authorized subscription service; and/or
the second determination module 52, configured to determine whether the UE is authorized to use the authorized subscription service.

An embodiment of the present disclosure provides an information processing apparatus that is applied to the ASMF network element, and may include: the second determination module 52, configured to query authorized management information of the unified data management (UDM) network element based on the identification information, to determine whether the UE has the authorized subscription service.

An embodiment of the present disclosure provides an information processing apparatus that is applied to the ASMF network element and may include: a second processing module, configured to obtain the target subscription information requested by the request information.

An embodiment of the present disclosure provides an information processing apparatus that is applied to the ASMF network element and may include: the second processing module, configured to obtain, based on the request information, the target subscription information requested by the request information from a unified data repository (UDR).

An embodiment of the present disclosure provides an information processing apparatus that is applied to the ASMF network element and may include: the second processing module, configured to determine the target subscription information according to the request information.

An embodiment of the present disclosure provides an information processing apparatus that is applied to the ASMF network element and may include: the second processing module, configured to determine, in response to determining that the UE has the authorized subscription service, the target subscription information according to the request information.

In some embodiments, the request information includes condition information.

An embodiment of the present disclosure provides an information processing apparatus that is applied to the ASMF network element and may include: the second processing module, configured to obtain, based on the condition information, at least part of the target subscription information indicated by the condition information.

In some embodiments, the target information further includes the identification information of the UE.

As shown in FIG. 17, an embodiment of the present disclosure provides an information processing apparatus that is applied to a UDM network element and may include:
a third receiving module 61, configured to receive request information sent by an AMF network element; where the request information includes identification information of UE;
a third determination module 62, configured to determine, based on the identification information, whether the UE has an authorized subscription service; and
a third sending module 63, configured to send, in response to determining that the UE has the authorized subscription service, requested target information to the AMF network element; where the target information includes target subscription information requested by the request information.

An embodiment of the present disclosure provides an information processing apparatus that is applied to the UDM network element and may include: the third receiving module 61, configured to receive a registration request message sent by the AMF network element and carrying request information.

An embodiment of the present disclosure provides an information processing apparatus that is applied to the UDM network element and may include: the third receiving module 61, configured to receive a service request message sent by the AMF network element and carrying request information.

An embodiment of the present disclosure provides an information processing apparatus that is applied to the UDM network element and may include:
the third determination module 62, configured to determine whether the UE subscribes to the authorized subscription service;
and/or,
the third determination module 62, configured to determine whether the UE is authorized to use the authorized subscription service.

An embodiment of the present disclosure provides an information processing apparatus that is applied to the UDM network element and may include: the third determination module 62, configured to query authorized management information of the unified data management (UDM) network element based on the identification information, to determine whether the UE has the authorized subscription service.

An embodiment of the present disclosure provides an information processing apparatus that is applied to the UDM network element and may include: a third processing module, configured to obtain the target subscription information requested by the request information.

An embodiment of the present disclosure provides an information processing apparatus that is applied to the UDM network element and may include: the third processing module, configured to obtain, based on the request information, the target subscription information requested by the request information from a unified data repository (UDR).

An embodiment of the present disclosure provides an information processing apparatus that is applied to the UDM network element and may include: the third processing module, configured to determine the target subscription information according to the request information.

An embodiment of the present disclosure provides an information processing apparatus that is applied to the UDM network element and may include: the third processing module, configured to determine, in response to determining that the UE has the authorized subscription service, the target subscription information according to the request information.

In some embodiments, the request information includes condition information.

An embodiment of the present disclosure provides an information processing apparatus that is applied to the UDM network element and may include: a third obtaining module, configured to obtain, based on the condition information, at least part of the target subscription information indicated by the condition information.

In some embodiments, the target information further includes the identification information of the UE.

As shown in FIG. 18, an embodiment of the present disclosure provides an information processing apparatus that is applied to UE and may include:
a fourth sending module 71, configured to send request information; where the request information includes identification information of the UE; and
a fourth receiving module 72, configured to receive target information that is returned based on the request information; where the target information is sent by the network device when determining that the UE has an authorized subscription service; the target information includes at least target subscription information requested by the request information.

An embodiment of the present disclosure provides an information processing apparatus that is applied to the UE and may include:
the fourth sending module 71, configured to send the request information to the AMF network element; where the request information includes identification information of the UE; and
the fourth receiving module 72, configured to receive target information that is sent by the AMF network element based on the request information; where the target information is sent by the network device when determining that the UE has an authorized subscription service; the target information includes at least target subscription information requested by the request information.

An embodiment of the present disclosure provides an information processing apparatus that is applied to the UE and may include: the fourth sending module 71, configured to send a registration request message carrying the request information.

An embodiment of the present disclosure provides an information processing apparatus that is applied to the UE and may include: the fourth sending module 71, configured to send a service request message carrying the request information.

In some embodiments, the identification information is for the network device to determine at least one of:
whether the UE subscribes to the authorized subscription service; or
whether the UE is authorized to use the authorized subscription service.

An embodiment of the present disclosure provides an information processing apparatus that is applied to the UE and may include: a fourth determination module, configured to determine that the UE subscribes to the authorized subscription service and/or the UE is authorized to use the authorized subscription service.

In some embodiments, the request information is for the network device to determine the target subscription information requested by the request information.

In some embodiments, the request information includes condition information, where the condition information is for the network device to determine a part or all of the target subscription information, indicated by the condition information.

In some embodiments, the network devices include an AMF network element, an ASMF network element, and a UDM network element.

In some embodiments, the target information further includes the identification information of the UE.

It should be noted that those skilled in the art may understand that the apparatuses provided in the embodiments of the present disclosure may be executed separately, or may be executed together with some apparatuses in the embodiments of the present disclosure or some apparatuses in related technologies.

The specific manners in which each of the modules of the apparatus in the above embodiments executes operations have been described in detail in the embodiments related to the method, and will not be explained here in detail.

An embodiment of the present disclosure provides a communication device, including:
a processor; and
a memory configured to store instructions executable by the processor;
where the processor is configured to implement, when executing the executable instructions, the information processing method in any embodiment of the present disclosure.

In an embodiment, the communication device may include but is not limited to at least one of: UE and a network device. Here, the network device may include a core network device, an access network device, or the like. Here, the access network device may include a base station, and the core network device may include an AMF network element, an ASMF network element, or a UDM network element.

The processor may include various types of storage mediums. The storage mediums are non-transitory computer storage mediums, and can continue to memorize information stored in the storage mediums after the user equipment is powered off.

The processor may be connected to the memory by a bus or the like, to read an executable program stored in the memory, to implement for example, at least one of the methods shown in FIGS. 2 to 14.

An embodiment of the present disclosure further provides a computer storage medium, storing a computer executable program. When the executable program is executed by a processor, the information processing method of any embodiment of the present disclosure is implemented, for example, at least one of the methods shown in FIGS. 2 to 14.

The specific manners in which each of the modules of the apparatus or storage mediums in the above embodiments executes operations have been described in detail in the embodiments related to the method, and will not be explained here in detail.

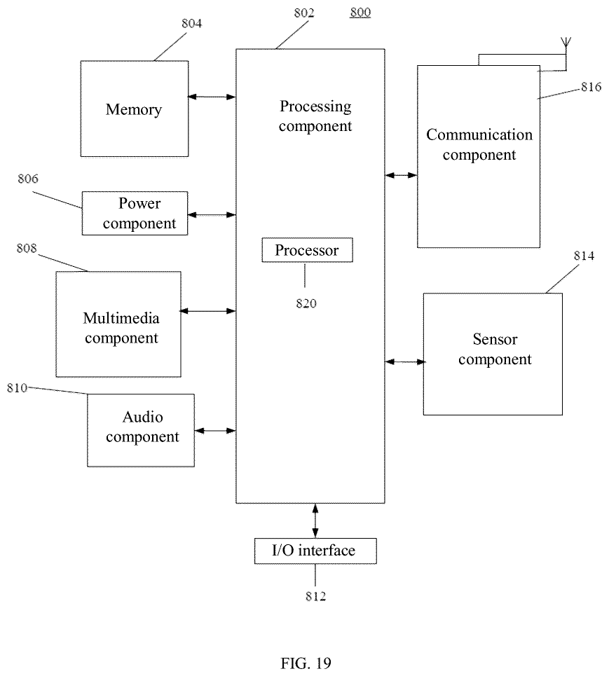

FIG. 19 is a block diagram of user equipment 800 shown according to an exemplary embodiment. For example, the user equipment 800 may be a mobile phone, a computer, digital broadcast user equipment, a message transceiving device, a game console, a tablet device, a medical device, a fitness device, a personal digital assistant, etc.

Referring to FIG. 19, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the user equipment 800, such as operations associated with display, phone calls, data communication, camera operations, and recording operations. The processing component 802 may include one or more processors 820 to execute instructions to complete all or part of the steps in the above methods. Additionally, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations of the user equipment 800. Examples of such data include instructions, contact data, phonebook data, messages, pictures, videos, etc., for any application program or method operating on the user equipment 800. The memory 804 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power to various components of the user equipment 800. The power component 806 may include a power supply management system, one or more power supplies, and other components that are associated with generating, managing, and distributing power for the user equipment 800.

The multimedia component 808 includes a screen providing an output interface between the user equipment 800 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense a boundary of the touch or slide action, but also detect a duration and pressure related to the touch or slide operation. In some embodiments, the multimedia component 808 includes a front facing camera and/or a rear facing camera. When the user equipment 800 is in an operation mode, such as a shooting mode or a video mode, the front facing camera and/or the rear facing camera may receive external multimedia data. Each of the front facing and rear facing camera may be a fixed optical lens system or have a focal length and an optical zoom capability.

The audio component 810 is configured to output and/or input audio signals. For example, the audio component 810 includes a microphone (MIC). The microphone is configured to receive external audio signals when the user equipment 800 is in the operating mode, such as a call mode, a recording mode, and a speech recognition mode. The received audio signals may be further stored in the memory 804 or sent via the communication component 816. In some embodiments, the audio component 810 also includes a speaker to output the audio signals.

The I/O interface 812 provides an interface between the processing component 802 and peripheral interface modules. The peripheral interface modules may be keyboards, click wheels, buttons, etc. These buttons may include but are not limited to: a home button, a volume button, a start button, and a lock button.

The sensor component 814 includes one or more sensors to provide various aspects of state assessment for the user equipment 800. For example, the sensor component 814 may detect an open/closed state of the user equipment 800, relative positioning of components that are for example a display and keypad of the user equipment 800. The sensor component 814 may also detect a position change of the user equipment 800 or of a component of the user equipment 800, presence or absence of the user contacting with the user equipment 800, an orientation or acceleration/deceleration of the user equipment 800, and a temperature change of the user equipment 800. The sensor component 814 may include a proximity sensor configured to detect the presence of nearby objects without any physical contact. The sensor component 814 may also include a light sensor, such as a CMOS or CCD image sensor, for use in an imaging application. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the user equipment 800 and other devices. The user equipment 800 may access a wireless network based on a communication standard, such as WiFi, 4G, 5G, or a combination of them. In an exemplary embodiment, the communication component 816 receives, via a broadcast channel, a broadcast signal or broadcast related information from an external broadcast management system. In an exemplary embodiment, the communication component 816 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the user equipment 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to execute the above methods.

In an exemplary embodiment, a non-transitory computer-readable storage medium including instructions is further provided, such as the memory 804 including the instructions. The above instructions may be executed by the processor 820 of the user equipment 800 to complete the above methods. For example, the non-transitory computer-readable storage medium may be a ROM, a random access memory (RAM), a CD-ROM, a magnetic tape, a floppy disk, an optical data storage device, etc.

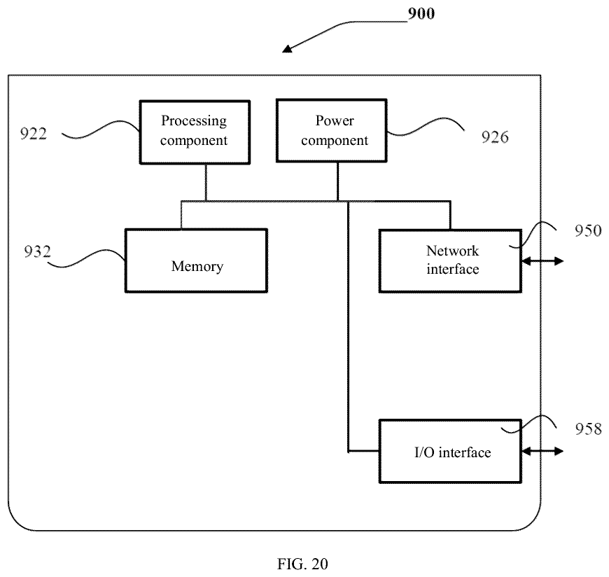

As shown in FIG. 20, an embodiment of the present disclosure shows a structure of a base station. For example, the base station 900 may be provided as a network-side device. Referring to FIG. 20, the base station 900 includes a processing component 922 that further includes one or more processors, and memory resources represented by a memory 932, for storing instructions that is executable by the processing component 922, such as an application program. The application program stored in the memory 932 may include one or more modules that each corresponds to a set of instructions. In addition, the processing component 922 is configured to execute instructions to execute any method applied to the base station in the above methods.

The base station 900 may also include a power component 926 configured to execute power management of the base station 900, a wired or wireless network interface 950 configured to connect the base station 900 to the network, and an input/output (I/O) interface 958. The base station 900 may operate an operating system stored in the memory 932, such as Windows Server™, Mac OS X™, Unix™, Linux™, FreeBSD™, or a similar operating system.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

1. An information processing method, executed by an access and mobility management function (AMF) network element and comprising:
receiving request information sent by user equipment (UE); wherein the request information comprises identification information of the UE;
determining, based on the identification information, whether the UE has an authorized subscription service; and
sending, in response to determining that the UE has the authorized subscription service, requested target information to the UE; wherein the requested target information comprises subscription information requested by the request information.

2. The information processing method of claim 1, wherein the determining, based on the identification information, whether the UE has the authorized subscription service comprises:
querying, based on the identification information, authorized management information of a unified data management (UDM) network element, and determining whether the UE has the authorized subscription service.

3. (canceled)

4. The information processing method of claim 1, wherein the request information comprises condition information, and the information processing method further comprises:
obtaining, based on the condition information, at least part of the target subscription information indicated by the condition information.

5. The information processing method of claim 1, further comprising:
obtaining the subscription information requested by the request information;
wherein the obtaining the subscription information requested by the request information comprises:
obtaining, based on the request information, the subscription information requested by the request information from a unified data repository (UDR); or
wherein the obtaining the subscription information requested by the request information comprises: sending the request information to an authorized subscription management function (ASMF) network element; and receiving the subscription information that is returned by the ASMF network element based on the request information; or
wherein the obtaining the subscription information requested by the request information comprises: sending the request information to a UDM network element; and receiving the subscription information that is returned by the UDM network element based on the request information.

6. (canceled)

7. The information processing method of claim 5, wherein the sending the request information to an ASMF network element comprises:
sending, in response to determining that the UE has the authorized subscription service, the request information to the ASMF network element.

8. (canceled)

9. The information processing method of claim 5, wherein the sending the request information to the UDM network element comprises:
sending, in response to determining that the UE has the authorized subscription service, the request information to the UDM network element.

10. (canceled)

11. The information processing method of claim 1, wherein the receiving request information comprises any one of:
receiving a registration request message sent by the UE and carrying the request information; or
receiving a service request message sent by the UE and carrying the request information.

12. An information processing method, executed by an authorized subscription management function (ASMF) network element and comprising:
receiving request information sent by an access and mobility management function (AMF) network element; wherein the request information comprises identification information of UE;
determining, based on the identification information, whether the UE has an authorized subscription service; and
sending, in response to determining that the UE has the authorized subscription service, requested target information to the AMF network element; wherein the requested target information comprises subscription information requested by the request information.

13. The information processing method of claim 12, wherein the determining, based on the identification information, whether the UE has the authorized subscription service comprises:
querying, based on the identification information, authorized management information of a unified data management (UDM) network element, to determine whether the UE has the authorized subscription service.

14. The information processing method of claim 12, further comprising:
obtaining the subscription information requested by the request information.

15. The information processing method of claim 14, wherein the request information comprises condition information; the obtaining the subscription information requested by the request information comprises:
obtaining, based on the condition information, at least part of the subscription information indicated by the condition information.

16. The information processing method of claim 14, wherein the obtaining the subscription information requested by the request information comprises:
obtaining, based on the request information, the subscription information requested by the request information from a unified data repository (UDR); or
wherein the obtaining the subscription information requested by the request information comprises: determining, according to the request information, the subscription information; wherein the determining, according to the request information, the subscription information comprises: determining, in response to determining that the UE has the authorized subscription service, the subscription information according to the request information.

17-19. (canceled)

20. The information processing method of claim 12, wherein the receiving request information sent by an access and mobility management function (AMF) network element comprises any one of:
receiving a registration request message sent by the AMF network element and carrying the request information; or
receiving a service request message sent by the AMF network element and carrying the request information.

21. An information processing method, executed by a unified data management (UDM) network element and comprising:
receiving request information sent by an access and mobility management function (AMF) network element; wherein the request information comprises identification information of UE;
determining, based on the identification information, whether the UE has an authorized subscription service; and
sending, in response to determining that the UE has the authorized subscription service, requested target information to the AMF network element; wherein the requested target information comprises subscription information requested by the request information.

22. The information processing method of claim 21, wherein the determining, based on the identification information, whether the UE has the authorized subscription service comprises:
querying, based on the identification information, authorized management information of the UDM network element, to determine whether the UE has the authorized subscription service.

23. The information processing method of claim 21, further comprising:
obtaining the subscription information requested by the request information.

24. The information processing method of claim 23, wherein the request information comprises condition information, the obtaining the subscription information requested by the request information comprises:
obtaining, based on the condition information, at least part of the subscription information indicated by the condition information.

25. The information processing method of claim 23, wherein the obtaining the subscription information requested by the request information comprises:
obtaining, based on the request information, the subscription information requested by the request information from a unified data repository (UDR); or
wherein the obtaining the subscription information requested by the request information comprises: determining, according to the request information, the subscription information; wherein the determining, according to the request information, the subscription information comprises: determining, in response to determining that the UE has the authorized subscription service, the subscription information according to the request information.

26-48. (canceled)

49. A communication device, comprising:
one or more processors; and
a memory storing instructions executable by the one or more processors;
wherein the one or more processors are configured to execute the instructions and instructions cause the one or more processors to collectively execute the method of claim 1.

50. A non-transitory computer storage medium, storing a program executable by one or more processors; wherein when the program when executed by the one or more processors cause the one or more processors to execute the information processing method of claim 1.
